(19) United States
(12) Patent Application Publication
(10) Pub. No.: US 2009/0019211 A1
(43) Pub. Date: Jan. 15, 2009

(54) Establishing A Redundant Array Of Inexpensive Drives

(75) Inventors: Justin P. Bandholz, Cary, NC (US); Kevin M. Reinberg, Chapel Hill, NC (US); Philip L. Weinstein, Apex, NC (US); Christopher C. West, Raleigh, NC (US)

Correspondence Address: IBM (RPS-BLF);c/o BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 11/777,691

(22) Filed: Jul. 13, 2007

(51) Int. Cl. G06F 12/00

(52) U.S. Cl. 711/103; 711/E12.008

(57) ABSTRACT

Establishing, with a USB RAID controller connected to a USB hub and with USB mass storage devices connected to the USB hub and the USB RAID controller through USB connectors, the USB hub controlled by a USB host controller, a RAID array including enumerating, by the USB host controller, the USB mass storage devices, including discovering the USB RAID controller; receiving, by the USB RAID controller from a RAID console application program, an instruction to designate USB connectors as RAIDable USB connectors, the instruction including selected USB connectors; designating, by the USB RAID controller, the selected USB connectors as RAIDable USB connectors; enumerating by the USB RAID controller the USB mass storage devices connected to the RAIDable USB connectors; configuring by the USB RAID controller a RAID array, the RAID array including the USB mass storage devices; and storing, through the USB RAID controller, computer data on the RAID array.

### BACKGROUND OF THE INVENTION

1. Field of the Invention

The field of the invention is data processing, or, more specifically, methods, apparatus, and products for establishing a redundant array of inexpensive drives (‘RAID’).

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

One of the areas in which progress has been made is in RAID arrays. Data corruption is a primary concern in this information age. Currently, most data is stored on spinning disk hard drives that have many moving parts. Consequently, these spinning hard drives are susceptible to random failures due to crashes and so on. In enterprise systems, RAID controllers are frequently used to add a level of robustness to the data storage system by utilizing multiple drives to store data so that the data can be recovered should a failure occur.

Solid state storage devices are fast approaching the data storage capacity of conventional spinning hard drives. Solid state storage devices have no moving parts, and generally have longer mean time before failure (‘MTBF’) ranges and wider thermal characteristics than do spinning disk devices. Currently, there are RAID controllers in existence that have a USB upstream port and a downstream port converter that converts to one of the standard hard drive connection interfaces, such as IDE, SATA, SCSI, or SAS. Placing this type of hard drive interface on a USB solid state storage device, however, adds a significant amount of complexity and cost to the device.

### SUMMARY OF THE INVENTION

Methods, apparatus, and products for establishing a RAID array are disclosed, the methods, apparatus, and products implemented with a universal serial bus (‘USB’) RAID controller connected to a USB hub and with USB mass storage devices, the USB mass storage devices connected to the USB hub and the USB RAID controller through USB connectors, the USB hub controlled by a USB host controller, the methods, apparatus, and products including enumerating, by the USB host controller, the USB mass storage devices, including discovering the USB RAID controller; receiving, by the USB RAID controller from a RAID console application program, an instruction to designate USB connectors as RAIDable USB connectors, the instruction including selected USB connectors; designating, by the USB RAID controller, the selected USB connectors as RAIDable USB connectors; enumerating by the USB RAID controller the USB mass storage devices connected to the RAIDable USB connectors; configuring by the USB RAID controller a RAID array, the RAID array including the USB mass storage devices; and storing, through the USB RAID controller, computer data on the RAID array.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of automated computing machinery comprising an exemplary computer useful in establishing a redundant array of inexpensive drives according to embodiments of the present invention.

FIG. 2 sets forth a flow chart illustrating an exemplary method for establishing a redundant array of inexpensive drives according to embodiments of the present invention.

FIG. 3 sets forth a flow chart illustrating a further exemplary method for establishing a redundant array of inexpensive drives according to embodiments of the present invention.

FIG. 4 sets forth a flow chart illustrating a further exemplary method for establishing a redundant array of inexpensive drives according to embodiments of the present invention.

### DETAILED DESCRIPTION OF EXEMPLARY EMBODIMENTS

### Detailed Description

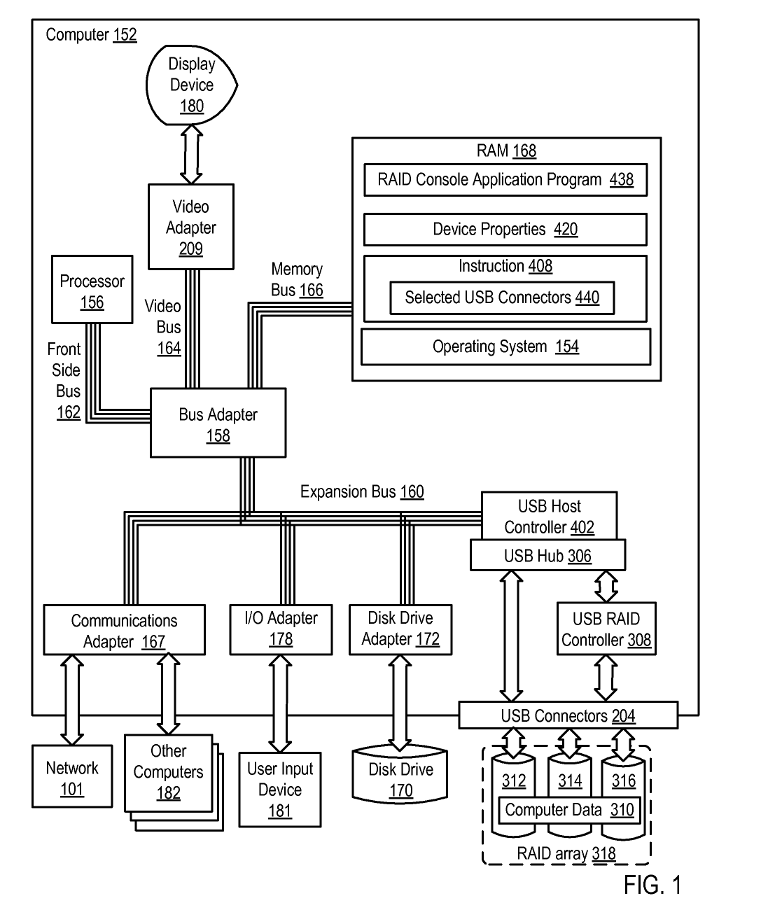

Exemplary methods, systems, and products for establishing a redundant array of inexpensive drives according to embodiments of the present invention are described with reference to the accompanying drawings, beginning with FIG. 1. Establishing a redundant array of inexpensive drives in accordance with the present invention is generally implemented with computers, that is, with automated computing machinery. FIG. 1 sets forth a block diagram of automated computing machinery comprising an exemplary computer (152) useful in establishing a redundant array of inexpensive drives according to embodiments of the present invention. The computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer.

The exemplary computer (152) of FIG. 1 also includes a universal serial bus (‘USB’) host controller (402). The USB architecture provides a serial bus standard for connecting together devices such as, for example, computers, game consoles, personal digital assistants, televisions, stereo equipment, and so on. The Universal Serial Bus Specification Revision 2.0 (‘USB Specification’) jointly authored by Compaq, Hewlett-Packard, Intel, Lucent, Microsoft, NEC, and Philips sets forth the standard for developing USB components and communicating among the components. USB components include, for example, devices, cables, hubs, hosts, ports, interfaces, mass storage devices, and so on. In USB terminology, the exemplary computer (152) containing the host controller (402) is referred to as a ‘host.’ The USB host controller (402) provides an interface for other components of the exemplary computer (152) to utilize USB hubs and USB devices connected to USB connectors (204). The USB host controller (402) may be implemented as a combination of hardware, firmware, or software. The exemplary USB host controller (402) of FIG. 1 controls the USB hub (306). A USB hub is a device that allows many USB devices to be connected to a single USB port on a host computer or another hub.

The exemplary computer (152) of FIG. 1 also includes a USB RAID controller connected to the USB hub (306). A RAID controller manages the physical storage units in a RAID array and presents them to a host computer as logical units. RAID controllers may be implemented with software, firmware, or hardware. The term is sometimes used to refer to a host bus adapter (‘HBA’), but it properly refers to the hardware, software, or firmware which implements the RAID logic. The RAID controller may be integrated with an HBA, or it may be part of an independent enclosure, such as a disk array, a network-attached storage (‘NAS’) server, or a Storage Area Network (‘SAN’). The exemplary RAID controller (308) of FIG. 1 is described here as a ‘USB’ RAID controller because the RAID controller is connected to a USB port (not shown) on the USB hub (306).

In the example of FIG. 1, USB mass storage devices (312, 314, 316) are connected to both the USB hub (306) and USB RAID controller (308) through USB connectors (204). A USB mass storage device is device that implements the USB mass storage device class (‘USB MSC’). The USB MSC is set of computing communications protocols defined by the USB Implementers Forum that run on the Universal Serial Bus. The standard provides an interface to a variety of storage devices. Some of the devices which are connected to computers via this standard include:
external magnetic hard drives;
external optical drives, including CD and DVD reader and writer drives;
portable flash memory devices, particularly keydrives;
adapters bridging between standard flash memory cards and a USB connection;
digital cameras;
digital audio players high-end hardware media players;
Card Readers;
Portable Gaming systems;
personal data assistants and handheld computers;
some newer mobile phones, such as the Sony Ericsson K800 and K510, Nokia N73, Nokia E61;
USB Keystroke loggers; and
others as will occur to those of skill in the art.

In the computer system (152) of FIG. 1, for example, at least one of the USB mass storage devices (312, 314, 316) may be a solid state drive (‘SSD’). A solid state drive is a data storage device that uses non-volatile or volatile solid-state memory to store persistent data. Solid state drives are an alternative to conventional hard disk drives, which have moving parts that usually result in slower memory access times. Solid state drives may be implemented with SDRAM, DRAM, or nonvolatile flash memory. Most SSD manufacturers use nonvolatile flash memory to create more rugged and compact alternatives to DRAM-based SSDs. These flash memory-based SSDs, also known as flash drives, do not require batteries. In addition, nonvolatility allows flash SSDs to retain memory even during sudden power outages, ensuring data retrievability. Just like DRAM SSDs, flash SSDs are extremely fast since these devices have no moving parts, eliminating seek time, latency and other electromechanical delays inherent in conventional disk drives. Although only three USB mass storage devices (312, 314, 316) are shown in the example of FIG. 1, persons of skill in the art will recognize that any number of USB mass storage devices may be used to establish a RAID array according to embodiments of the present invention.

In the exemplary computer (152) of FIG. 1, the USB host controller (402) establishes a RAID array according to embodiments of the present application by enumerating the USB mass storage devices (312, 314, 316), including discovering the USB RAID controller (308). The USB host controller may enumerate the USB mass storage devices by detecting the connection of the USB mass storage devices at the hub. Hubs have status bits that are used to report the attachment or removal of a USB device on one of its ports. The USB host controller queries the hub to retrieve these bits. In the case of an attachment, the host enables the port and addresses the USB device through the device's control pipe at a default address. A ‘pipe’ is a logical connection from a USB host controller to a logical entity on a USB hub or device named an ‘endpoint.’ The USB host controller assigns a unique USB address to the USB device and then determines whether the newly attached USB device is a hub or a function. USB devices are described as ‘functions’ because each individual physical device may actually host several functions, such as a webcam with a built-in microphone. The USB host controller determines whether the newly attached USB device is a hub or a function by retrieving hub and port configuration and control information from the USB hub through a ‘default control pipe’ connected to endpoint ‘0’ in the USB hub. If the attached USB device is a hub and USB devices are attached to its ports, then the above procedure is followed for each of the attached USB devices. If the attached USB device is a function, then attachment notifications will be handled by host software that is appropriate for the function, such as a device driver. Once the USB mass storage devices (312, 314, 316) are enumerated, the devices may be used as typical USB mass storage devices.

In the exemplary computer (152) of FIG. 1, the USB RAID controller (308) receives, from a RAID console application program (438) stored in RAM (168), an instruction (408) to designate USB connectors as RAIDable USB connectors. The instruction to designate USB connectors as RAIDable USB connectors includes selected USB connectors (440), that is, the connectors selected to be RAIDable USB connectors. A USB connector may be ‘RAIDable’ if the USB mass storage device connected to the USB connector is capable of being included in a RAID array. Once a USB connector is designated as a RAIDable connector, the USB mass storage device connected to the RAIDable connector is no longer capable of being used as a typical USB mass storage device. That is, the USB mass storage device connected to a RAIDable USB connector is only accessible through the USB RAID controller, not directly accessible by the USB hub. The RAID console application program (438) is a module of computer program instructions useful for establishing a redundant array of inexpensive drives according to embodiments of the present invention that enables a user to configure a RAID array. The user may configure the RAID array through the RAID console application program (438) by selecting the USB connectors to designate as RAIDable connectors. A USB hub useful for establishing a RAID array may have connectors designated for RAID operation as well as connectors designated for typical USB operation. For a hub connected to three USB mass storage devices and a USB keyboard, for example, a user may select as RAIDable connectors only the three connectors for the USB mass storage devices. The USB keyboard, being directly connected to the USB host controller, may be used in the typical manner.

The exemplary USB RAID controller (308) of FIG. 1 also designates the selected USB connectors (440) as RAIDable USB connectors. USB connectors useful for establishing a RAID in accordance with embodiments of the present invention are connected to the USB host controller (306) and the USB RAID controller (308) through multiplexers (not shown), and designating (412) the selected USB connectors (440) as RAIDable USB connectors is carried out by sending, by the USB RAID controller (308) to the multiplexers, a selection signal. The selection signal causes the multiplexers to electrically connect the selected USB connectors to USB RAID controller. The electrical path through the multiplexers typically electrically connects the USB connectors to the USB host directly. When the RAID controller sends the multiplexers the selection signal, however, the electrical path switches, electrically connecting the USB connectors to the RAID controllers and disabling the direct path to the USB host. That is, when the multiplexer receives a selection signal the electrical path through the multiplexer switches from connecting the USB mass storage devices directly to the USB hub, to connecting the USB mass storage devices to the USB RAID controller. The USB mass storage devices connected to the connectors are no longer accessible directly by the USB hub, but are only accessible through USB RAID controller. Readers of skill in the art will immediately recognize that designating USB connectors as RAIDable USB connectors may be carried out by using any other means for changing the electrical path from the USB connector and the USB hub to the USB RAID controller, such as for example, for example, a switch or logic gate.

The exemplary USB RAID controller (308) of FIG. 1 also enumerates the USB mass storage devices connected to the RAIDable USB connectors. When the USB RAID controller enumerates the USB mass storage devices connected to the RAIDable connectors the USB RAID controller retrieves device properties from each USB mass storage device. Device properties may include the capacity of the USB mass storage device, the device's USB specification, the device's product and vendor identification, and so on. When the USB mass storage devices are enumerated, the exemplary USB RAID controller (308) of FIG. 1 configures a RAID array (318) that includes the USB mass storage devices (312, 314, 316) and then stores computer data (310) on the RAID array (318).

Stored in RAM (168) of the exemplary computer (152) is an operating system (154). Operating systems useful in computers according to embodiments of the present invention include UNIX™, Linux™, Microsoft Vista™, Microsoft XP™, AIX™, IBM's i5/OS™, and others as will occur to those of skill in the art. Operating system (154) and the RAID Console Application Program (438) in the example of FIG. 1 are shown in RAM (168), but many components of such software typically are stored in non-volatile memory also, for example, on a disk drive (170).

The computer (152) of FIG. 1 includes a bus adapter (158), a computer hardware component that contains drive electronics for the high speed buses, the front side bus (162), the video bus (164), and the memory bus (166), as well as drive electronics for the slower expansion bus (160). Examples of bus adapters useful for establishing a redundant array of inexpensive drives according to embodiments of the present invention include the Intel Northbridge, the Intel Memory Controller Hub, the Intel Southbridge, and the Intel I/O Controller Hub. Examples of expansion buses useful for establishing a redundant array of inexpensive drives according to embodiments of the present invention include Industry Standard Architecture (‘ISA’) buses and Peripheral Component Interconnect (‘PCI’) buses.

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers include Integrated Drive Electronics (‘IDE’) adapters, Small Computer System Interface (‘SCSI’) adapters, and others as will occur to those of skill in the art. In addition, non-volatile computer memory may be implemented for a computer as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters in computers implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 1 includes a communications adapter (167) for data communications with other computers (182) and for data communications with a data communications network (101). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for establishing a redundant array of inexpensive drives according to embodiments of the present invention include modems for wired dial-up communications, Ethernet (IEEE 802.3) adapters for wired data communications network communications, and 802.11 adapters for wireless data communications network communications.

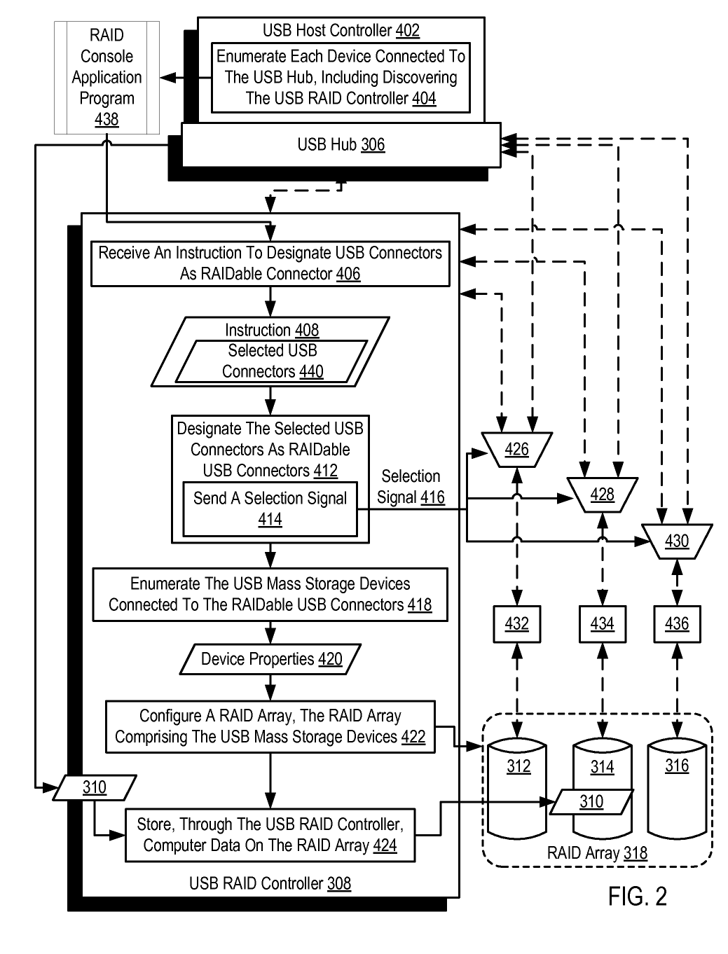

For further explanation, FIG. 2 sets forth a flow chart illustrating an exemplary method for establishing a redundant array of inexpensive drives according to embodiments of the present invention. The method of FIG. 2 is implemented with a universal serial bus (‘USB’) RAID controller (308) connected to a USB hub (306) and with USB mass storage devices (312, 314, 316). A USB hub is a device that allows many USB devices to be connected to a single USB port on a host computer or another hub. A USB mass storage device is device that implements the USB mass storage device class (‘USB MSC’). The USB MSC is set of computing communications protocols defined by the USB Implementers Forum that run on the Universal Serial Bus. The USB MSC standard provides an interface to a variety of storage devices. In the method of FIG. 2, for example, at least one of the USB mass storage devices (312, 314, 316) may be a solid state drive (‘SSD’). A solid state drive is a data storage device that uses non-volatile or volatile solid-state memory to store persistent data. Solid state drives are an alternative to conventional hard disk drives, which have moving parts that usually result in slower memory access times. Solid state drives may be implemented with SDRAM, DRAM, or nonvolatile flash memory. Most SSD manufacturers use nonvolatile flash memory to create more rugged and compact alternatives to DRAM-based SSDs. These flash memory-based SSDs, also known as flash drives, do not require batteries, allowing makers to replicate standard disk drive form factors (1.8-inch, 2.5-inch, and 3.5-inch). In addition, nonvolatility allows flash SSDs to retain memory even during sudden power outages, ensuring data retrievability. Just like DRAM SSDs, flash SSDs are extremely fast since these devices have no moving parts, eliminating seek time, latency and other electro-mechanical delays inherent in conventional disk drives. Although only three USB mass storage devices (312, 314, 316) are shown in the example of FIG. 2, persons of skill in the art will recognize that any number of mass storage devices may be used to establish a RAID array according to embodiments of the present invention. The USB mass storage devices (312, 314, 316) of FIG. 2 are connected to the USB hub (306) and the USB RAID controller (308) through USB connectors (432, 434, 436).

In the example of FIG. 2, the USB hub (306) is controlled by a USB host controller (402). A USB host controller connects a host system (such as the computer (152) of FIG. 1) to the USB hub (306). The USB host controller may be implemented as firmware on a USB expansion card or USB controller, or the USB host controller may be implemented as a software device driver in the operating system of the host system.

The method of FIG. 2 includes enumerating (404), by the USB host controller (402), the USB mass storage devices (312, 314, 316), including discovering the USB RAID controller (308). The USB host controller may enumerate the USB mass storage devices by detecting the connection of the USB mass storage devices at the hub. Hubs have status bits that are used to report the attachment or removal of a USB device on one of its ports. The USB host controller queries the hub to retrieve these bits. In the case of an attachment, the host enables the port and addresses the USB device through the device's control pipe at a default address. A ‘pipe’ is a logical connection from a USB host controller to a logical entity on a USB hub or device named an ‘endpoint.’ The USB host controller assigns a unique USB address to the USB device and then determines whether the newly attached USB device is a hub or a function. USB devices are described in as a ‘functions’ because each individual physical device may actually host several functions, such as a webcam with a built-in microphone. The USB host controller determines whether the newly attached USB device is a hub or a function by retrieving hub and port configuration and control information from the USB hub through a ‘default control pipe’ connected to endpoint ‘0’ in the USB hub. If the attached USB device is a hub and USB devices are attached to its ports, then the above procedure is followed for each of the attached USB devices. If the attached USB device is a function, then attachment notifications will be handled by host software that is appropriate for the function, such as a device driver. Once the USB mass storage devices (312, 314, 316) are enumerated, the devices may be used as typical USB mass storage devices.

The method of FIG. 2 also includes receiving (406), by the USB RAID controller (308) from a RAID console application program (438), an instruction (408) to designate USB connectors (426, 428, 430) as RAIDable USB connectors, the instruction (408) including selected USB connectors (440). A USB connector may be ‘RAIDable’ if the USB mass storage device connected to the USB connector is capable of being included in a RAID array. Once a USB connector is designated as a RAIDable connector, the USB mass storage device connected to the RAIDable connector is no longer capable of being used as a typical USB mass storage device. That is, the USB mass storage device connected to a RAIDable USB connector is only accessible through the USB RAID controller, not directly accessible by the USB hub. The RAID console application program (438) is a module of computer program instructions useful for establishing a redundant array of inexpensive drives according to embodiments of the present invention that enables a user to configure a RAID array. The user may configure the RAID array by selecting the USB connectors to designate as RAIDable connectors. A USB hub useful for establishing a RAID may have connectors designated for RAID operation as well as connectors designated for typical USB operation. For a hub connected to three USB mass storage devices and a USB keyboard, for example, a user may select as RAIDable connectors only the three connectors for the USB mass storage devices. The USB keyboard, being directly connected to the USB host controller, may be used in the typical manner.

The method of FIG. 2 also includes designating (412), by the USB RAID controller (308), the selected USB connectors (440) as RAIDable USB connectors. In the method of FIG. 2, the USB connectors (432, 434, 436) are connected to the USB host controller (306) and the USB RAID controller (308) through multiplexers (426, 428, 430), and designating (412) the selected USB connectors (440) as RAIDable USB connectors is carried out by sending (414), by the USB RAID controller (308) to the multiplexers (426, 428, 430), a selection signal (416). The selection signal (416) causes the multiplexers to electrically connect the selected USB connectors (440) to USB RAID controller (308). The electrical path through the multiplexer typically electrically connects the USB connectors to the USB host directly. When the RAID controller sends the multiplexers the selection signal, however, the electrical path switches, electrically connecting the USB connectors to the RAID controllers and disabling the direct path to the USB host. That is, when the multiplexer receives a selection signal (416) electrical path through the multiplexer switches from connecting the USB mass storage devices directly to the USB hub, to connecting the USB mass storage devices to the USB RAID controller. When the electrical path is switched, the USB mass storage devices connected to the connectors are no longer accessible directly by the USB hub, but are only accessible through USB RAID controller.

The method of FIG. 2 also includes enumerating (418) by the USB RAID controller (308) the USB mass storage devices (318) connected to the RAIDable USB connectors (432, 434, 436). When the USB RAID controller enumerates the USB mass storage devices connected to the RAIDable connectors the USB RAID controller retrieves device properties from each USB mass storage device. Device properties may include the capacity of the USB mass storage device, the device's USB specification, the devices product identification and vendor identification, and so on.

The method of FIG. 2 also includes configuring (422) by the USB RAID controller (308) a RAID array (318), the RAID array (318) including the USB mass storage devices (312, 314, 316) and storing (424), through the USB RAID controller (308), computer data (310) on the RAID array (318). The USB RAID controller may configure the USB RAID array as any RAID level, RAID 0, RAID 1, and so on. Such RAID level may be specified in table stored in computer memory of the USB RAID controller, specified in an instruction received from the RAID console application program, specified by a device driver for the USB RAID controller, or specified in other ways as will occur to those of skill in the art. The USB RAID controller (308) may receive computer data from the USB hub (306). The host system may initiate the storing of computer data from time to time either autonomously or in response to a user instruction to do so.

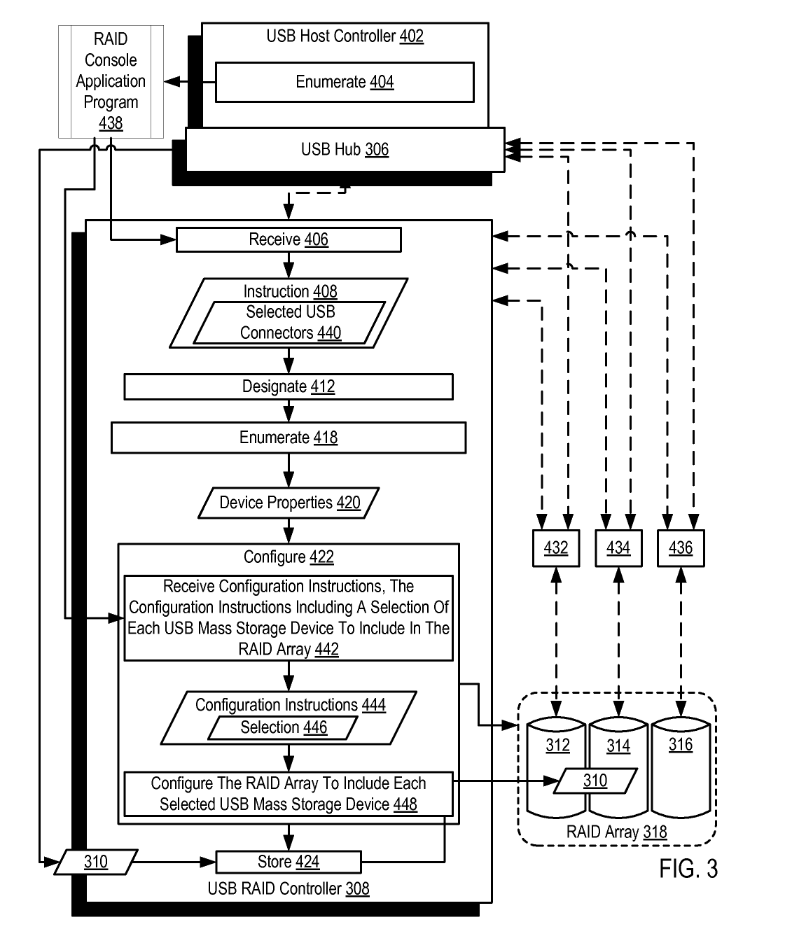

For further explanation, FIG. 3 sets forth a flow chart illustrating a further exemplary method for establishing a redundant array of inexpensive drives according to embodiments of the present invention. The method of FIG. 3 is similar to the method of FIG. 2 including, as it does, the USB host controller's (402) enumerating (404) the USB mass storage devices (312, 314, 316), the USB RAID controller's (308) receiving (406) an instruction (408) to designate USB connectors as RAIDable USB connectors, the USB RAID controller's (308) designating (412) the selected USB connectors (440) as RAIDable USB connectors, the USB RAID controller's (308) enumerating (418) the USB mass storage devices (312, 314, 316) connected to the RAIDable USB connectors (432, 434, 436), the RAID controller's configuring (422) a RAID array (318), and storing (424), through the USB RAID controller (308), computer data (310) on the RAID array (318), all of which operate as described above.

In the method of FIG. 3, however, configuring (422) a RAID array (318) is carried out by receiving (442), by the USB RAID controller (308) from the RAID console application program (438), configuration instructions (444), the configuration instructions (444) including a selection (446) of each USB mass storage device (312, 314, 316) to include in the RAID array (318). The method of FIG. 3 also includes configuring (448) the RAID array (318) to include each selected USB mass storage device (446). A user may select, through the RAID console application program, as many or as few of the USB mass storage devices attached to the RAIDable connectors to include in the RAID array. A user may for example, select two USB mass storage devices connected to the RAIDable connectors to include in a first RAID array and two other USB mass storage devices connected to the RAIDable connectors to include in a second RAID array. That is, multiple RAID arrays may be established. Readers of skill in the art will recognize that the configuration instructions may also include a specification of a number logical drives that comprise the RAID array and the size of each logical drive. That is, the RAID array (318) may be partitioned into logical divisions.

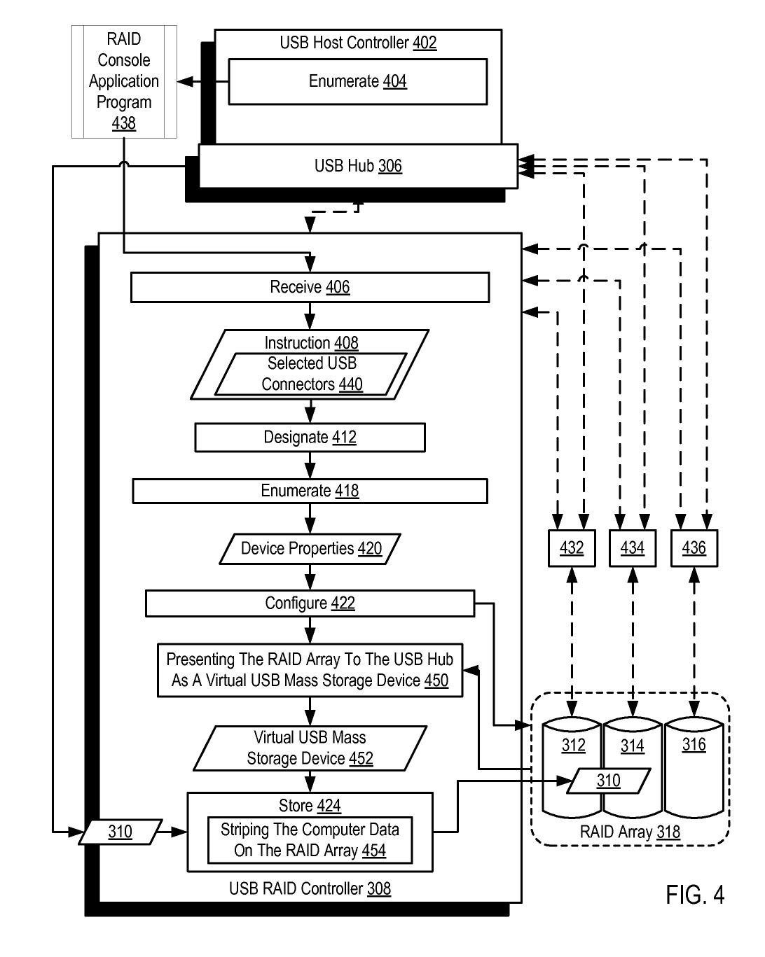

For further explanation, FIG. 4 sets forth a flow chart illustrating a further exemplary method for establishing a redundant array of inexpensive drives according to embodiments of the present invention. The method of FIG. 4 is similar to the method of FIG. 2 including, as it does, the USB host controller's (402) enumerating (404) the USB mass storage devices (312, 314, 316), the USB RAID controller's (308) receiving (406) an instruction (408) to designate USB connectors as RAIDable USB connectors, the USB RAID controller's (308) designating (412) the selected USB connectors (440) as RAIDable USB connectors, the USB RAID controller's (308) enumerating (418) the USB mass storage devices (312, 314, 316) connected to the RAIDable USB connectors (432, 434, 436), the RAID controller's configuring (422) a RAID array (318), and storing (424), through the USB RAID controller (308), computer data (310) on the RAID array (318), all of which operate as described above.

The method of FIG. 4, however also includes presenting (450) by the RAID controller to the USB hub (306) the RAID array (318) as a virtual USB mass storage device (452). The virtual USB mass storage device (452) is the interface presented by the USB RAID controller for use by a host system for reading and writing data from and to the RAID array. The RAID controller of FIG. 2 presents the RAID array as a virtual USB mass storage device (452), by initiating an enumeration of the devices connected to the USB hub and, during the enumeration, presenting to the USB host, hub and port configuration and control information indicating that a single USB mass storage device is connected to USB hub.

In the method of FIG. 4, storing (424) computer data (310) on the RAID array (318 further comprises striping (454) the computer data (310) on the RAID array (318). Striping refers to the segmentation of logically sequential data, such as a single file, so that segments can be written to multiple physical devices, such as for example, USB mass storage devices, in a round-robin fashion. A USB transaction typically consists of a token packet that is as a header defining the following packets, a data packet containing a payload, and a status packet used to acknowledge transactions and to provide a means of error correction. The computer data (310) of FIG. 4 is included in such a USB data packet. If the USB RAID controller is configured to stripe incoming computer data on the RAID array (318) the USB RAID controller may stripe the computer data (310) on the RAID array by breaking the body of data in the USB data packet into units and spreading these units across the USB mass storage device. The size of the unit may be specified in a table stored in computer memory of the RAID controller or may be specified by a user through the RAID console application program. Persons of skill in the art will recognize that there are a number of other ways to store computer data on the RAID array including mirroring the computer data on the RAID array.

Exemplary embodiments of the present invention are described largely in the context of a fully functional computer system for establishing a redundant array of inexpensive drives. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of establishing a redundant array of inexpensive drives (‘RAID’), the method implemented with a universal serial bus (‘USB’) RAID controller connected to a USB hub and with USB mass storage devices, the USB mass storage devices connected to the USB hub and the USB RAID controller through USB connectors, the USB hub controlled by a USB host controller, the method comprising:
enumerating, by the USB host controller, the USB mass storage devices, including discovering the USB RAID controller;
receiving, by the USB RAID controller from a RAID console application program, an instruction to designate USB connectors as RAIDable USB connectors, the instruction including selected USB connectors;
designating, by the USB RAID controller, the selected USB connectors as RAIDable USB connectors;
enumerating by the USB RAID controller the USB mass storage devices connected to the RAIDable USB connectors;
configuring by the USB RAID controller a RAID array, the RAID array comprising the USB mass storage devices; and
storing, through the USB RAID controller, computer data on the RAID array.

2. The method of claim 1 wherein the USB connectors are connected to the USB host controller and the USB RAID controller through multiplexers and
designating the selected USB connectors as RAIDable USB connectors further comprises:
sending, by the USB RAID controller to the multiplexers, a selection signal, the selection signal causing the multiplexer to electrically connect the selected USB connectors to USB RAID controller.

3. The method of claim 1 wherein configuring a RAID array further comprises:
receiving, by the USB RAID controller from the RAID console application program, configuration instructions, the configuration instructions including a selection of each USB mass storage device to include in the RAID array; and
configuring the RAID array to include each selected USB mass storage device.

4. The method of claim 1 further comprising presenting by the RAID controller to the USB hub, the RAID array as a virtual USB mass storage device.

5. The method of claim 1 wherein at least one of the USB mass storage devices comprises a solid state drive.

6. The method of claim 1 wherein storing computer data on the RAID array further comprises striping the computer data on the RAID array.

7. An apparatus for establishing a RAID array, the apparatus comprising a universal serial bus (‘USB’) RAID controller connected to a USB hub, the apparatus further comprising USB mass storage devices, the USB mass storage devices connected to the USB hub and the USB RAID controller through USB connectors, the USB hub controlled by a USB host controller, the apparatus further comprising a computer processor, a computer memory operatively coupled to the computer processor, the computer memory having disposed within it computer program instructions capable of:
enumerating, by the USB host controller, the USB mass storage devices, including discovering the USB RAID controller;
receiving, by the USB RAID controller from a RAID console application program, an instruction to designate USB connectors as RAIDable USB connectors, the instruction including selected USB connectors;
designating, by the USB RAID controller, the selected USB connectors as RAIDable USB connectors;
enumerating by the USB RAID controller the USB mass storage devices connected to the RAIDable USB connectors;
configuring by the USB RAID controller a RAID array, the RAID array comprising the USB mass storage devices; and
storing, through the USB RAID controller, computer data on the RAID array.

8. The apparatus of claim 7 wherein the USB connectors are connected to the USB host controller and the USB RAID controller through multiplexers and designating the selected USB connectors as RAIDable USB connectors further comprises:
sending, by the USB RAID controller to the multiplexers, a selection signal, the selection signal causing the multiplexer to electrically connect the selected USB connectors to USB RAID controller.

9. The apparatus of claim 7 wherein configuring a RAID array further comprises:
receiving, by the USB RAID controller from the RAID console application program, configuration instructions, the configuration instructions including a selection of each USB mass storage device to include in the RAID array; and
configuring the RAID array to include each selected USB mass storage device.

10. The apparatus of claim 7 further comprising computer program instructions capable of presenting by the RAID controller to the USB hub, the RAID array as a virtual USB mass storage device.

11. The apparatus of claim 7 wherein at least one of the USB mass storage devices comprises a solid state drive.

12. The apparatus of claim 7 wherein storing computer data on the RAID array further comprises striping the computer data on the RAID array.

13. A computer program product for establishing a RAID array, the RAID array established with a universal serial bus (‘USB’) RAID controller connected to a USB hub and with USB mass storage devices, the USB mass storage devices connected to the USB hub and the USB RAID controller through USB connectors, the USB hub controlled by a USB host controller, the computer program product disposed upon a computer readable, signal bearing medium, the computer program product comprising computer program instructions capable of:
enumerating, by the USB host controller, the USB mass storage devices, including discovering the USB RAID controller;
receiving, by the USB RAID controller from a RAID console application program, an instruction to designate USB connectors as RAIDable USB connectors, the instruction including selected USB connectors;
designating, by the USB RAID controller, the selected USB connectors as RAIDable USB connectors;
enumerating by the USB RAID controller the USB mass storage devices connected to the RAIDable USB connectors;
configuring by the USB RAID controller a RAID array, the RAID array comprising the USB mass storage devices; and
storing, through the USB RAID controller, computer data on the RAID array.

14. The computer program product of claim 13 wherein the signal bearing medium comprises a recordable medium.

15. The computer program product of claim 13 wherein the signal bearing medium comprises a transmission medium.

16. The computer program product of claim 13 wherein the USB connectors are connected to the USB host controller and the USB RAID controller through multiplexers and designating the selected USB connectors as RAIDable USB connectors further comprises:
sending, by the USB RAID controller to the multiplexers, a selection signal, the selection signal causing the multiplexer to electrically connect the selected USB connectors to USB RAID controller.

17. The computer program product of claim 13 wherein configuring a RAID array further comprises:
receiving, by the USB RAID controller from the RAID console application program, configuration instructions, the configuration instructions including a selection of each USB mass storage device to include in the RAID array; and
configuring the RAID array to include each selected USB mass storage device.

18. The computer program product of claim 13 further comprising computer program instructions capable of presenting by the RAID controller to the USB hub, the RAID array as a virtual USB mass storage device.

19. The computer program product of claim 13 wherein at least one of the USB mass storage devices comprises a solid state drive.

20. The computer program product of claim 13 wherein storing computer data on the RAID array further comprises striping the computer data on the RAID array.
